(19) United States
(12) Patent Application Publication
(10) Pub. No.: US 2009/0106313 A1
(43) Pub. Date: Apr. 23, 2009

(54) Interactive prescription processing and managing system

(76) Inventor: Randy Boldyga, Annapolis, MD (US)

Correspondence Address: Alfred F. Hoyte, Esq., 7734 16th Street N.W., Washington, DC, 20012, US

(21) Appl. No.: 11/976,336

(22) Filed: Oct. 23, 2007

(51) Int. Cl. G06F 17/30; G06F 3/048

(52) U.S. Cl. 707/104.1; 715/764; 707/E17.005

(57) ABSTRACT

An electronic prescription processing system. The system allows users to process prescriptions for multiple patients, access individual patient and medication data over a computer network and to use that data to perform all tasks necessary to fill and refill prescriptions including, checking for drug interactions, alerting the user of alternative medications, and numerous other tasks useful for managing one or more prescriptions for one or multiple patients.

### 1. BACKGROUND OF THE INVENTION

The present invention relates in general to an electronic prescription processing system. More particularly, it relates to an interactive system for processing prescriptions for multiple patients, which allows the user to access individual patient and medication data over a computer network and to use that data, inter alia, to fill and refill prescriptions, check for drug interactions, and alert the user of alternative medications, and perform numerous other tasks useful for managing one or more prescriptions for one or multiple patients.

### STATEMENT OF THE PRIOR ART

Prescription management software has been available for several years and has developed to the point where it can be used with desktop as well as handheld (PDA) computing devices. The software typically performs the basic function of allowing a practitioner, i.e., a doctor, to write and verify a prescription. U.S. Pat. No. 7,072,840 shows a representative software prescription management scheme. The software allows the practitioner to write a prescription, and includes subroutines which present various options and alternatives with respect to the type and dosage of medication, given predetermined patient profiles. This system and other software driven prescription management schemes are satisfactory for the limited purpose of creating an optimal drug formulation for a given set of patient conditions or a specific illness, but are not useful for performing the abundant tasks required of a practitioner who must manage multiple patient profiles, remain updated on various drug formularies for multiple health care providers as well as alerts for medications, select one or more pharmacies and maintain an electronic status of prescriptions submitted thereto, and perform numerous other tasks.

None of the above inventions and patents, taken either singly or in combination, is seen to describe the instant invention as claimed.

### SUMMARY OF THE INVENTION

The present invention overcomes the disadvantages of the prior art by providing an electronic prescription processing system. The system allows users to process prescriptions for multiple patients, access individual patient and medication data over a computer network and to use that data to perform all tasks necessary to fill and refill prescriptions including, checking for drug interactions, alerting the user of alternative medications, and numerous other tasks useful for managing one or more prescriptions for one or multiple patients.

Accordingly, it is an object of the invention to provide an improved electronic prescription processing system.

It is another object of the invention to provide a comprehensive electronic prescription processing system which can manage all aspects of the prescription writing process.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 shows a diagrammatic overview of the system of the present invention.

FIG. 2 shows a log-in screen.

FIG. 3 shows a user specific patient data screen.

FIG. 4A shows a prescriptions pending approval screen accessed via a tab on the patient data screen.

FIG. 4B shows a voided prescriptions screen accessed via a tab on the patient data screen.

FIG. 5 shows a new prescription initiation screen.

FIG. 6A shows a patient's prescription history screen accessed via a tab on the patient profile screen.

FIG. 6B shows a patient's active prescriptions screen accessed via a tab on the patient profile screen.

FIG. 6C shows a patient's claims history screen accessed via a tab on the patient profile screen.

FIG. 6D shows a patient's allergies screen accessed via a tab on the patient profile screen.

FIG. 6E shows a patient's active diagnosis screen accessed via a tab on the patient profile screen.

FIG. 7 shows a medication search screen.

FIG. 8 shows an alternative medication search screen.

FIG. 9A shows a prescription creation screen listing both custom and recommended sigs.

FIG. 9B shows a patient specific medication allergies and interaction screen.

FIG. 9C shows a patient education/monograph screen.

FIG. 9D shows a custom sig creation screen.

FIG. 9E shows a formulary alternative screen.

FIG. 10A shows a custom sig parameters and review screen.

FIG. 10B shows a prescription scheduling screen.

FIG. 11 shows a pharmacy search screen.

FIG. 12 shows a prescription preview screen.

FIG. 13 shows a user specific utilities management and preference selection screen.

FIG. 14 shows a messages screen.

FIG. 15 shows a reports screen.

### DETAILED DESCRIPTION

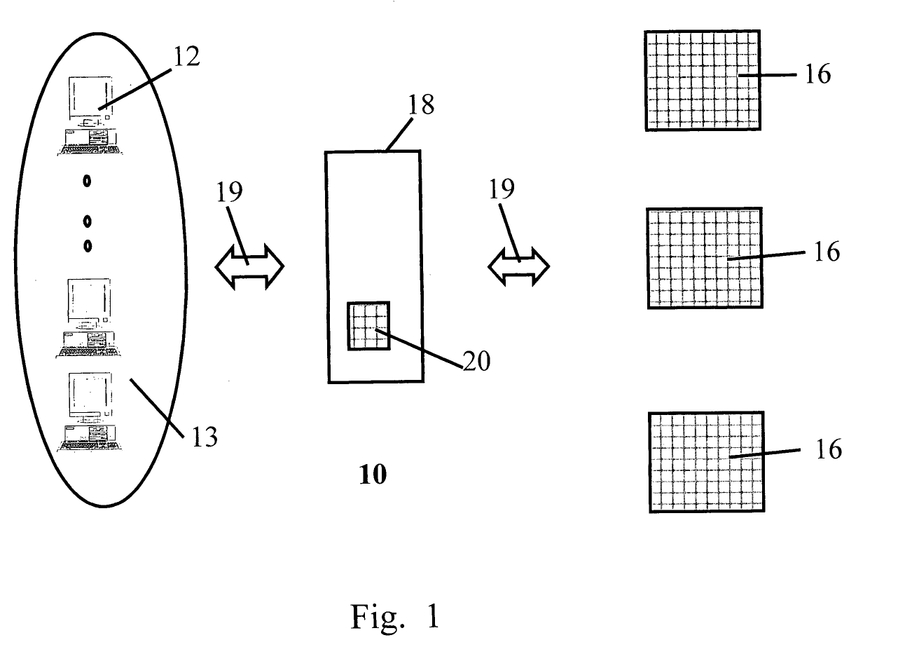

Referring now to FIGS. 1-15 a diagrammatic overview of the system 10, as well as the various information inputting, accessing, editing, and managing screens associated with the system 10 of the present invention are shown. With particular reference to FIG. 1, the system 10 may be provided as software for use with a single computing device such as a PC 12, or a network of computers 13 associated with a particular entity or entities engaged in the practice of medicine such as a pharmacy or doctor's office; which computing device 12, 13 may be selectively connected by one or more electronic networks 19 to various remote computing resources 16, including the host computing facility 18 of the present invention, either by wire or wirelessly via, e.g., the internet or world wide web 19. The computing devices 12, 13 are of course operated by prescribers, i.e., users authorized by the e.g., a health care provider, pharmacy, or doctor's office, to access system 10, the level of access granted being variable as will be discussed later.

The host computing facility 18, which is of course operated by an entity engaged in the business of providing computing services and associated software to health care professionals as noted above, may include one or more servers 20 for volume data and program storage, including the software application necessary to implement the system 10, and allows for inputting, accessing, (i.e. data capture), and editing all data necessary to allow a practitioner to create, refill, and modify prescriptions for all patients. At least one intelligent client associated with the servers 20 allows for limited and secure access to the servers 20. The host computing facility 18 allows for selectively accessing the remote computing resources 16 for performing the various tasks associated with the system 10, the resources 16 providing data relating to patient identification, patient medical history, drug formulations and interactions for a given medical condition, Food and Drug Administration (FDA) alerts, as well as other information necessary for the implementation of the system 10 as will be explained in more detail later. A system administrator associated with computing facility 18 serves as a human interface to the system 10 and performs various tasks such as upgrading software, hardware maintenance, and communicating various reports and messages to users as is known in the art.

The system 10 of the invention can be broken down into four basic components useful for accessing and reviewing patient data such as illnesses, current and past prescriptions, etc., writing new prescriptions, and maintaining all aspects of a health care provider's prescription writing and management services. The first component of the system is the log-in and access component which identifies the user to the system and allows for a determination of the level of access to which the user is entitled. The second component allows the user to access and review patient data for all user entered patients in the system memory. This component allows the user to edit patient data as necessary, the patient data being displayed so as to allow all critical information associated with the patient to be readily ascertainable at a glance without the user having to resort to a comprehensive review of all patient data. The third component of the system is the prescription creation routine which gives the user flexibility when prescribing medication especially with respect to the requirements of the user's health care provider or insurer, and potentially dangerous drug interactions. The prescription creation routine is designed to force the user to review all protocols necessary to complete a prescription given various parameters such as drug formularies, allergies, etc. The fourth component of the system includes a plurality of database and system management routines which essentially encompass all aspects of prescription and computer system management pertaining to all users and all patients associated with a single health care provider, with the exception of those aspects mentioned above in reference to the first three components.

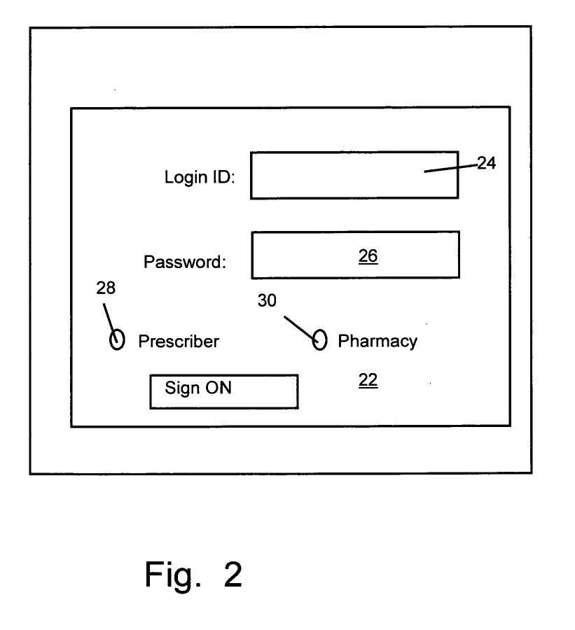

Referring now particularly to FIG. 2, the log-in screen 22 is shown. As the system 10 is primarily designed to be used with a PC, PDA, or other stand alone, single user computing device 12, 13, or a local area network of same, it is most advantageous to employ a software interface or browser with which most marginally computer savvy users are familiar. It should be noted that the terms user and practitioner are used interchangeably throughout this description, and refer variously to any health care professional such as a doctor, nurse, physicians assistant, pharmacist, or other authorized agent or employee of the entity engaged in the practice of medicine or and duly authorized to issue or process prescriptions. As such, the user is not required nor expected to be particularly well versed in the use of computers and computer software. Accordingly, the system 10 preferably employs the well known Internet Explorer® (IE) browser. The IE® browser comes pre-loaded on most computing devices capable of navigating an electronic network 19, and may be easily downloaded or otherwise obtained for use with the computing device 12. Of course, the system 10 may be adapted for use with any other browser, or with application software downloaded and stored on the computing device 12, and directed specifically for use with the system 10. It should also be noted that the system 10 application software and its subroutines are preferably written in JAVA to allow for the requisite transparency and facile integration with other software applications as would be apparent to one of skill in the art and will be explained in more detail later. It can be seen that access to the system 10 may be selectively obtained by authorized users, using IE® to enter in the universal resource locator or URL of the host computing facility 18. Once communication with the host 18 is established, the screen 22 shown in FIG. 1 will appear on the user's computing device 12 having data entry fields or boxes 24, 26 for inputting identification data (e.g. log-in ID and password) as is customary to allow for secure electronic access to a remote computing facility or server. Also, the user's status as either prescriber or pharmacy is indicated by “clicking” with the computer's mouse or other navigational tool (not shown) in the areas 28, 30 on the log-in screen 22. In accordance with one aspect of the system 10, one or more subroutines may be rendered inaccessible for users not authorized to create prescriptions. This aspect of the system 10 may be implemented by adding additional areas on the log in screen 22 further identifying the user status, or by using encryption software not apparent to the user which can be implemented by the system administrator using methods well known to those of skill in the art. The method of selecting an active icon, tab or data entry box is well known and is variously described by the term “clicking” or “selecting” throughout this description. Once the required identification data has been entered, the user signs in by clicking the sign in button 32, initiating access to the server 20 and the application software residing thereon and useful for implementing the system 10 of the invention.

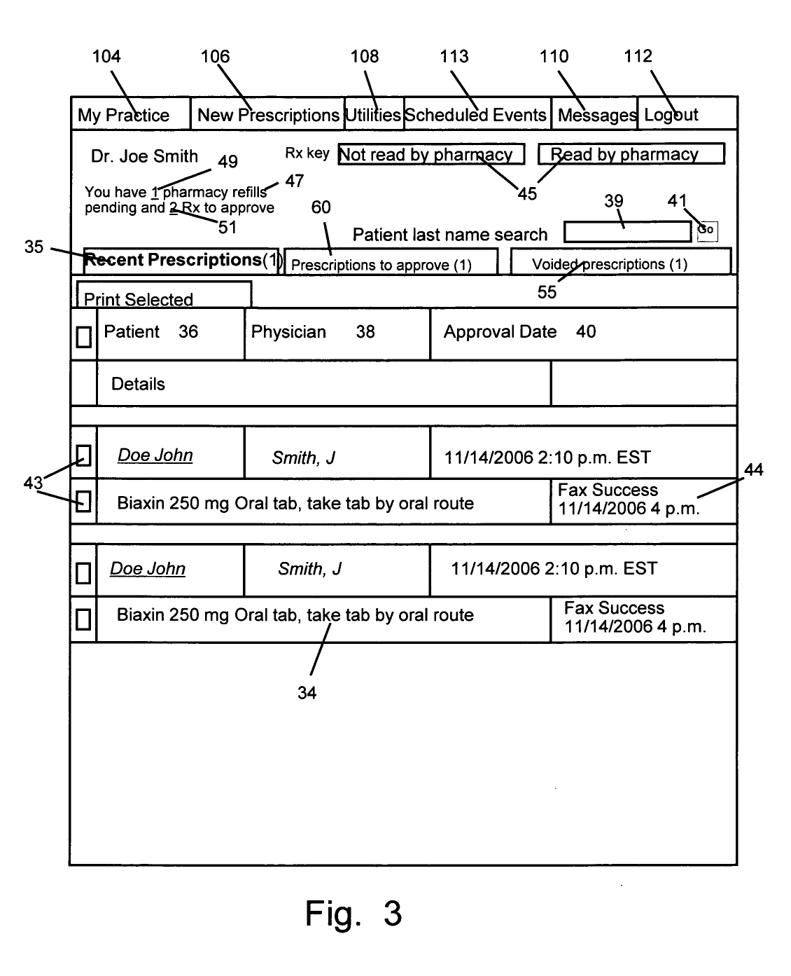

Referring now to FIG. 3 the patient and prescription data screen 34, the first screen shown after log-in, is shown, the screen 34 having a patient data grid with several columns relating to patient data, and three tabs allowing access to additional patient data. Data for all of the patients can be displayed on this screen, and the data is selectively viewable by operating a scroll feature or button. For practitioners having lengthy patient lists, in lieu of scrolling, a user may click in the data entry box labeled “Patient Last Name Search” 39, the search initiated by clicking on the go button 41 causing the display of the searched for patient's name at the top of the patient data grid.

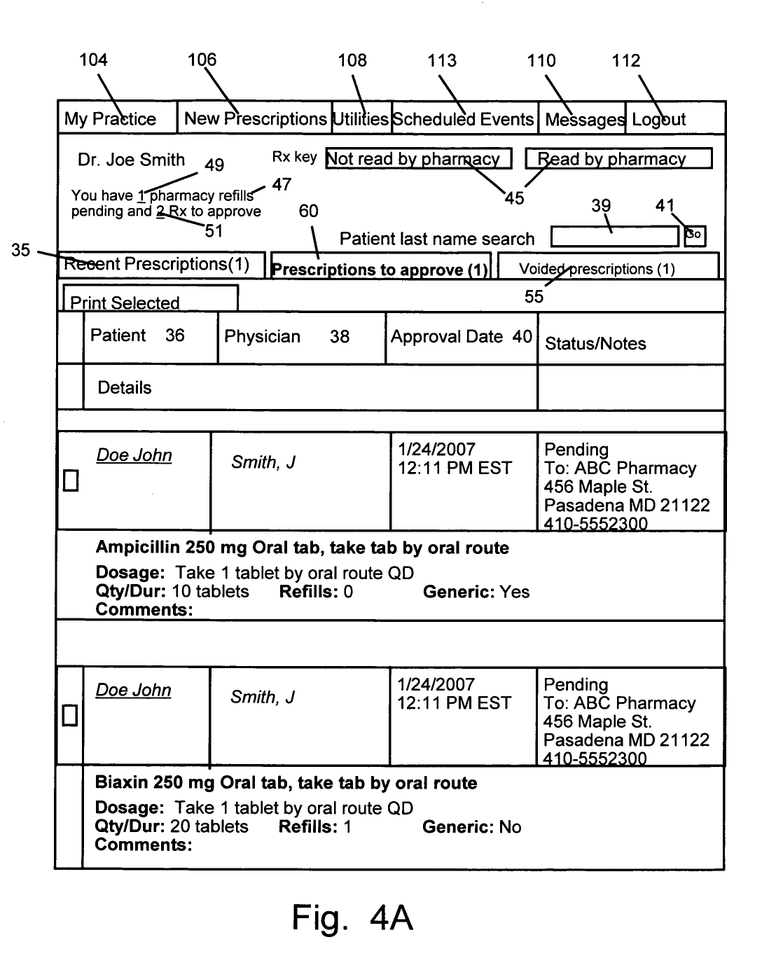

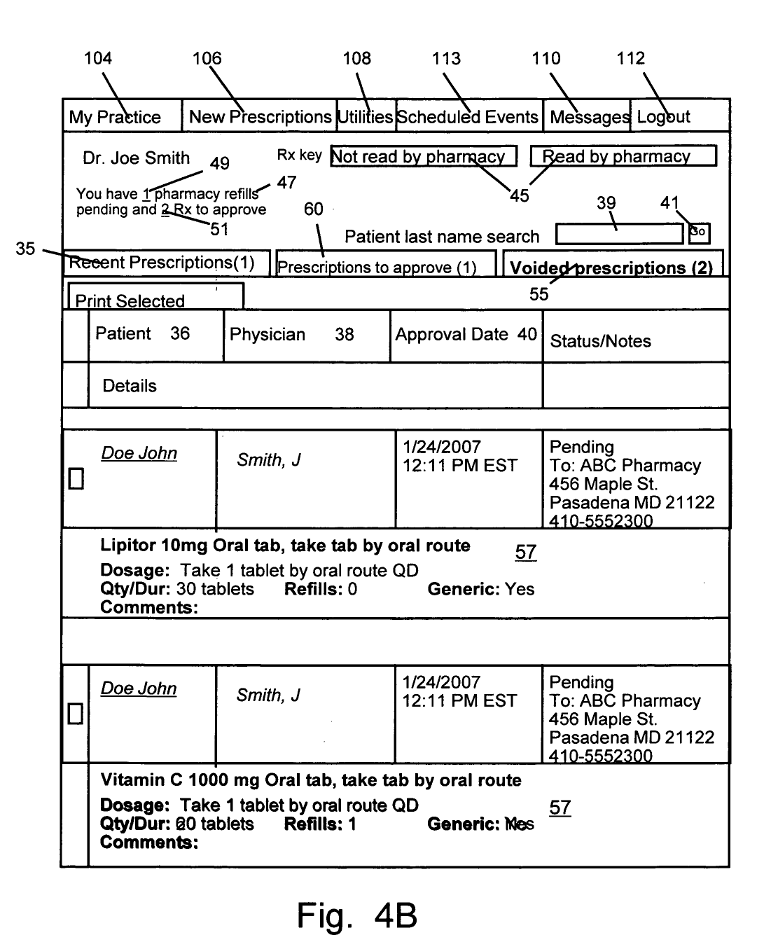

The recent prescriptions tab 35 displays data arranged in four columns, the first column 36 lists the patient's names, preferably in chronological order from most recent to least recent, the names presented in html format to allow for clicking to access. Column two 38 lists the prescribing physician(s) and column three 40 the approval date of the prescriptions. The status of any prescription may be discerned at a glance by referring to column four 42 which has time stamped and color coded entries relating to all prescriptions. Specifically, the time that the prescription was received by the pharmacy is indicated by the appropriate text indicia, and the status is indicated by color in the boxes 44 of column 42. If the prescription is highlighted by green coloring in box 44 the prescription has been received (electronically via network 19) by the pharmacy 14, if highlighted by yellow coloring, the prescription has not been received. The coloring is arbitrary, with a pair of indicia bearing non-active icons 45 indicating the significance of the coloring of the highlight in boxes 44. Acknowledgment of receipt of the prescription is performed automatically by host computer 18 using techniques well known to those of skill in the art. Check boxes 43, which are vertically aligned one per prescription on the left side of the screen 34 allow for selecting one or more prescriptions for printing. A single line of highlighted text 47 alerts the practitioner to any pharmacy or staff refills pending approval, the number of pharmacy or staff refills, 49, 51 respectively, indicated by html indicia in numeric form. The staff refills are those refills requested by a member of the practitioner's staff not authorized to issue prescriptions, while pharmacy refills are those which are transmitted to the system 10 by a pharmacy. Clicking on either indicia 49, 51 results in the display of screen 60, as does clicking on the prescription to approve tab 53. Clicking on the voided prescriptions tab 55 results in the display of a list of voided prescriptions 57 as shown in FIG. 4B.

Screen 60 shown in FIG. 4A lists all prescriptions needing doctor's approval pursuant to a request from a medical assistant or a refill request from a pharmacy 14. Pharmacy refill requests are entered by a pharmacist at a pharmacy using pharmacy software. The refill requests are transmitted to the user using industry standard prescription transmission methods (NCPDP SCRIPT standard). Physicians can limit a nurse or staff members access rights in the system requiring them to save the prescription for physician approval rather than transmit to the pharmacy, as has been explained above. Prescriptions awaiting approval are arranged on screen 60 on a patient by patient basis, preferably in alphabetical order from top to bottom of the screen 60, with scroll bar 62 allowing the user to navigate up and down the list as needed. The data arrangement on screen 60 includes at least two rows of text boxes for each patient, the first row 64 segregated into four columns. The first column 66 containing at least the patient's name and date of birth, and optionally the phone number or contact information, the second column 68 containing the physician's name, the third column 70 the date and time the prescription was entered, and the fourth column 71 containing the status (e.g. pending, received by pharmacy etc.) and other information which may include the name and address of the pharmacy to which the prescription has been sent. The second row 72 includes the details of the prescription including at least the medication, dosage, quantity, number of refills, and whether or not the medication is generic. Space is provided for the practitioner to insert any comments deemed relevant or informative. Additional rows 74 are added as needed and include the same information about any additional medications as row 72. A data entry box 76 allows for the entry of search text to locate data for a specific patient, with the go button 78 initiating the search.

A single column 80 on the left side of the screen 60 immediately adjacent data rows 64, 72, and 74 contains check boxes 82, 84 to allow for selective voiding or approving of prescriptions. Check box 82 allows the user to check all boxes in the column simultaneously to obviate the need to check each box individually. Once checked, prescriptions for the selected patient are voided by clicking the void selected button 83, or approved by clicking the approve selected button 85. Once approved the system automatically transmits the prescription(s) to the pharmacy identified on the prescription(s). Printing of approved prescriptions may be initiated by clicking in the “Only Prescriptions” field 86 or the “All Options” field 88. If no prescriptions have been approved, the screen defaults to “none” field 90, indicating that no prescriptions have been approved. Once a prescription has been voided, it is transferred to the voided prescriptions file and can be viewed by selecting the voided prescriptions tab 55, which causes the voided prescriptions screen FIG. 4B to be displayed. These voided prescriptions 57 can not be reactivated, as the patient's condition and/or list of current medications may changed, but can be added again as described below.

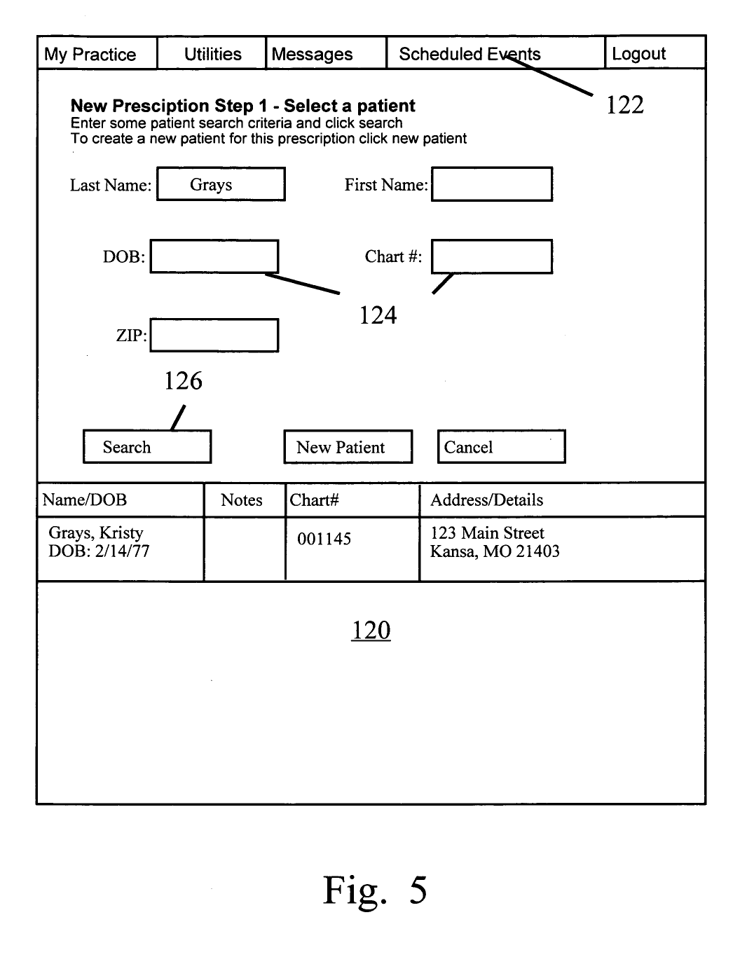

Across the top of patient data screen 34 and associated screens FIGS. 4A and B, is a navigational toolbar 102, having a plurality of buttons useful for navigating the system 10. The buttons include the “my practice” or patient data button 104, which initiates the patient data routine causing the display of the patient data screen 34, the new prescriptions button 106, the utilities button 108, and the scheduled events button 110. Clicking on the scheduled events button 110 displays a list of impending system events, e.g., scheduled system maintenance. Clicking on the new prescriptions 106 and utilities buttons 108 initiates subroutines which will be discussed later, and the logout button 112 disconnects the user from the host computer 20. Toolbar 102 also includes the messages button 113 which displays all system messages for the last 30 days. It should be noted that a “top of the screen” toolbar similar to toolbar 102 appears across the top of every screen or web page associated with the system except the log in screen, but is configured differently for some screens and thus is designated by a different reference numeral when appropriate. Also, this toolbar 102 may be modified in accordance with user preference as will be explained in more detail below. Referring now to FIG. 5, the new prescriptions screen 120, initiated by clicking the new prescriptions button 108 allows the user to begin the process of preparing a new prescription for a medication selected as described below. One of the advantages of the system 10 of the invention is that the subroutine for preparing the new prescriptions presents all of the relevant information and options to the user necessary to avoid the many dangers inherent in prescribing medications such as drug interaction problems, patient allergies, etc., the system 10 essentially forcing the user to review all patient data, drug interaction and options data, as well as any alerts concerning specific drugs. The navigational toolbar 122 at the top of the screen is essentially identical to toolbar 102, minus the new prescriptions button. Just below the toolbar 122 are several data entry boxes 124 for entering patient identification data such as first and last name, date of birth, chart or docket number, and zip code. The user may enter some or all of the data sufficient to uniquely identify the patient for whom a new prescription is to be written. A search for the patient's data is then initiated by clicking the search button 126. The system 10 automatically scrolls to the name of the desired patient if the search criteria is sufficiently narrow, or the name which most closely represents a “match” highlighting or otherwise making at least one patient's name visually distinguishable from the other names in the list 127. For a new patient, the user clicks on the new patient button 128 causing the display of a patient data entry screen (not shown) having a plurality of text entry fields with at least some of the fields indicated as necessary, and then must enter data into all of the necessary fields, and click on a button or icon which returns the user to screen. This type of data entry screen is well known in the art and usually allows for verification that all necessary data has been entered before allowing the user to proceed. The new patient's name is then displayed, in highlighted fashion, in the list. The user may exit the new prescriptions screen by clicking any of the buttons on the toolbar 122, or by clicking the cancel button 130.

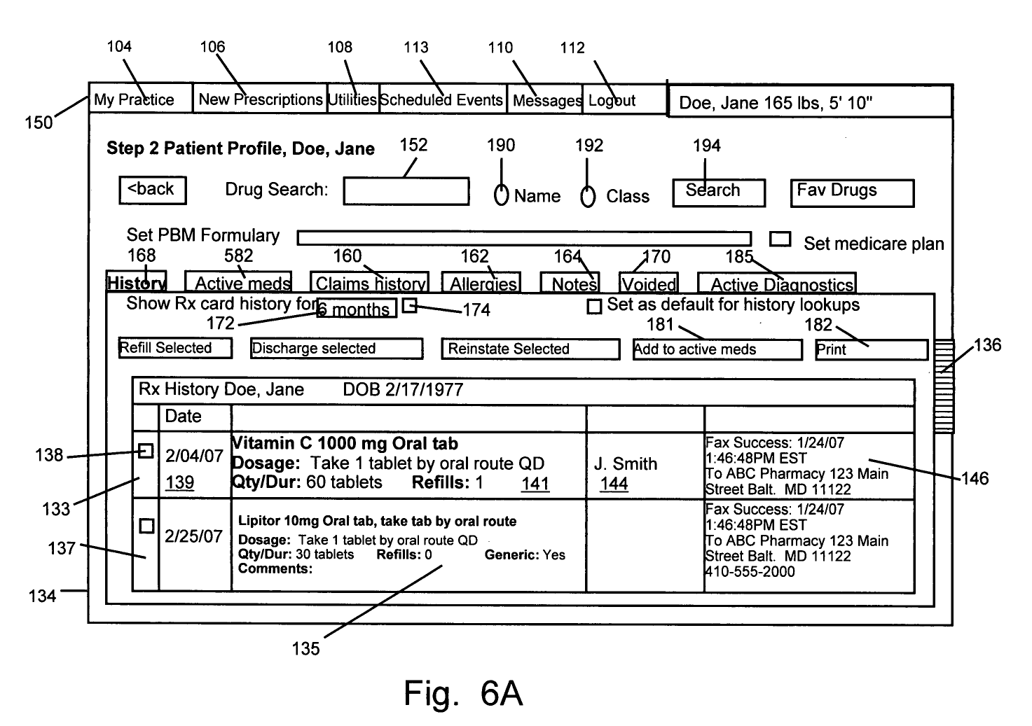

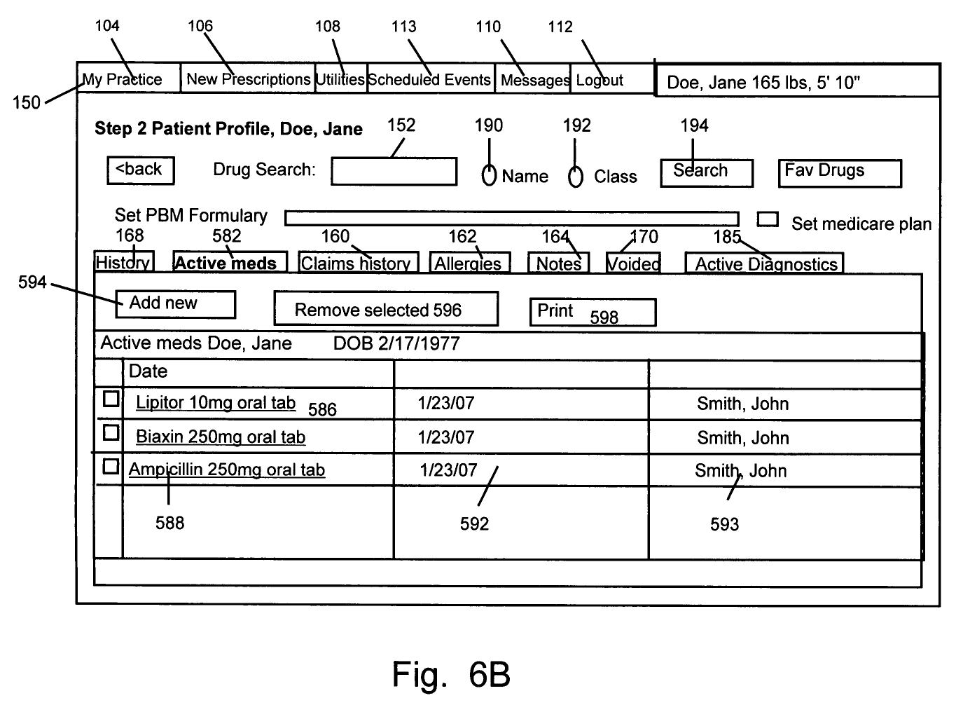

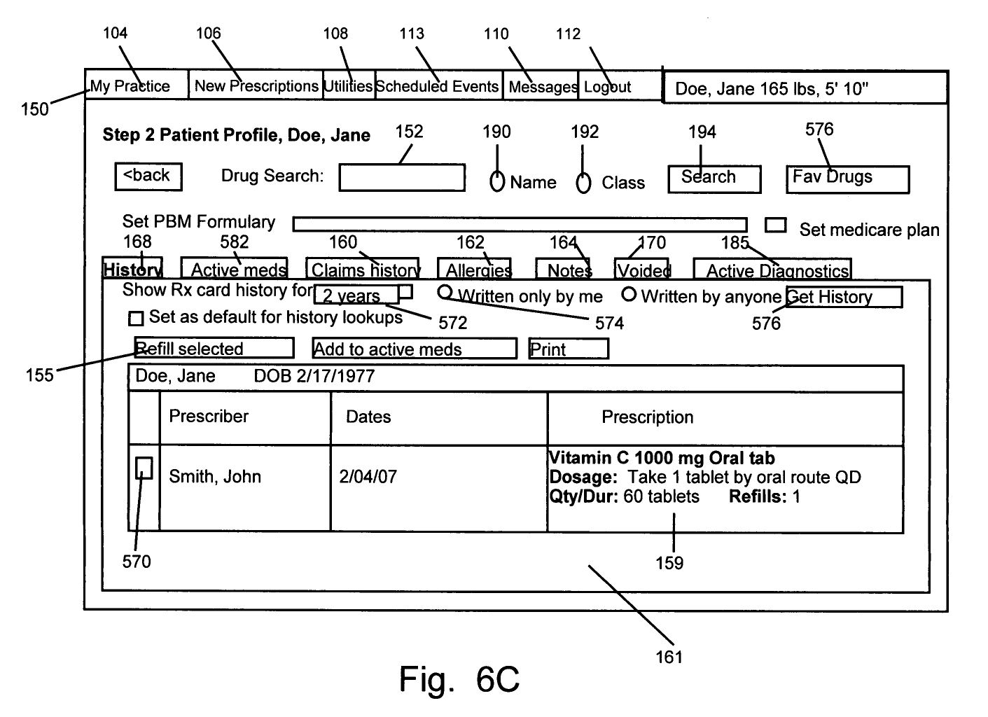

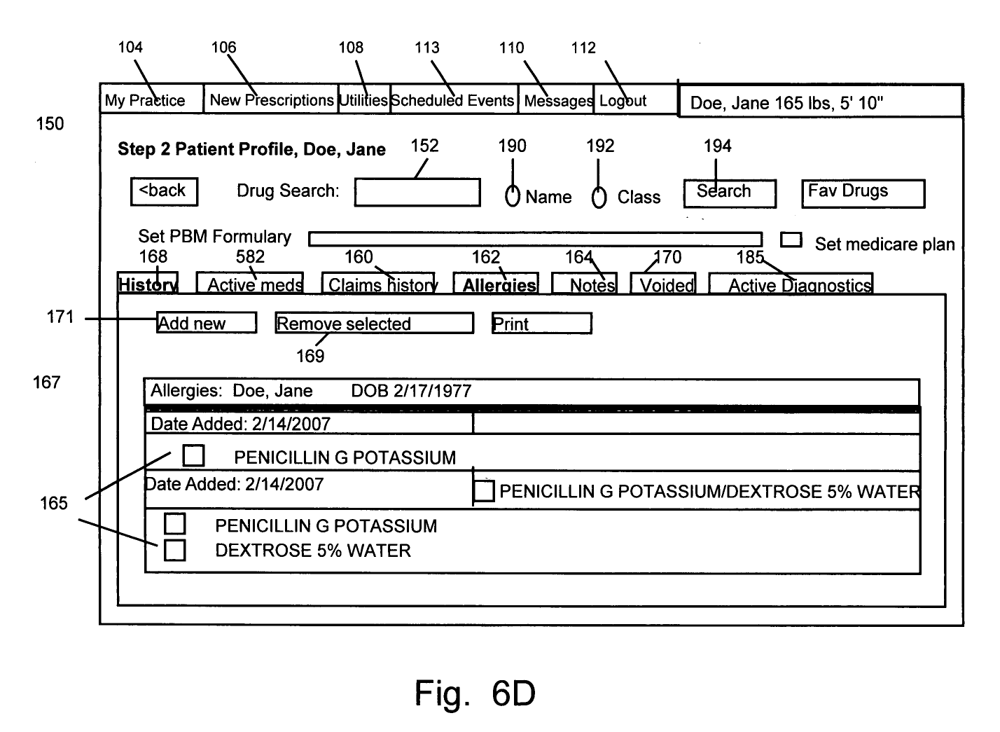

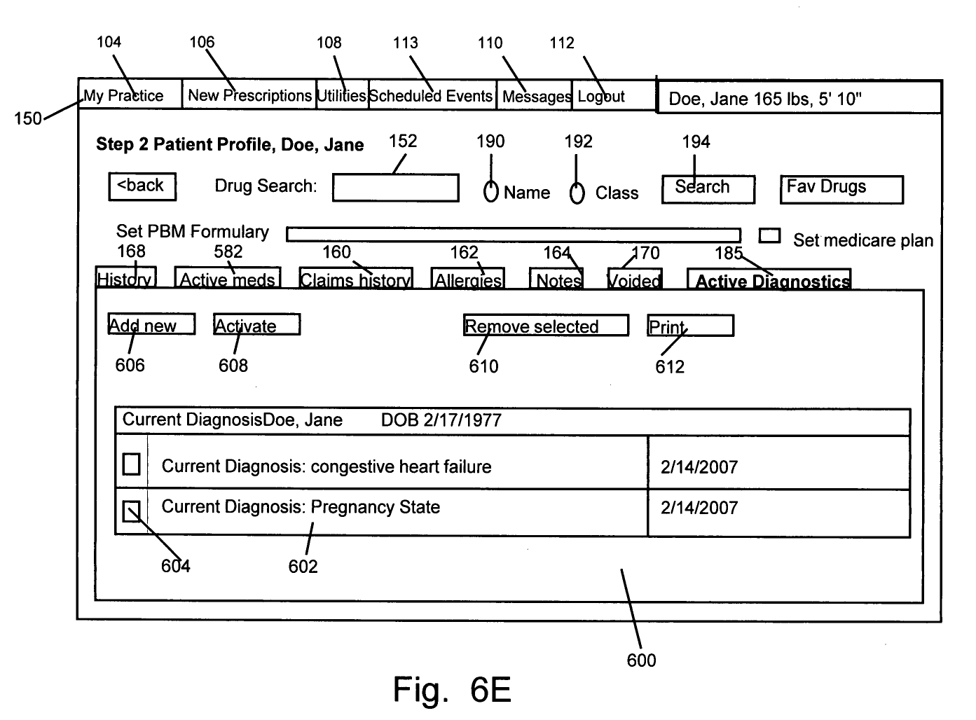

Clicking the highlighted patient's name on screen 120 causes display of the selected patient's profile screen 134 as shown in FIG. 6A, initiating the second step in the prescription writing process. Patient profile screen 134, which shows the patient's prescription history using the system 10, displays a list 135 of all medications prescribed for the selected patient using the system of the invention 10, the list arranged as a series of rows 137 divided into columns. Additional information concerning the patient's prescription and medical history can be obtained by clicking on the series of tabs near the top of screen 134, resulting in the display of a series of screens (FIG. 6B-6E) useful for performing the second step of the invention as will be explained in more detail later. Scroll bar 136 allows the user to scroll the list 135 as required to review the information associated with each prescription. The first column 133 has check boxes 138 for selecting a prescription, allowing various tasks such as prescription refill to be implemented for the selected prescription, as will be described later, and the second column 139 contains the date the prescription was written. Each prescription listed has at least the name of the medication, dosage, quantity, number of refills, and whether or not the medication is generic displayed in a third column 141. Space is provided in column 141 for the practitioner to insert any comments deemed relevant or informative, and also to display any such comments previously entered. Column 144 identifies the prescriber, and column 146 contains the pharmacy information. Toolbar 150 extends across the top of the screen 134 and is similar to toolbar 122, less the scheduled events button. Just below toolbar 150 a drug search field 152 is provided which allows a medication to be searched by name or by class by entering the appropriate text as will be explained in more detail below.

In recent years health insurance plans have employed pharmacy benefit managers (PBMs) to manage prescription medication benefits. The PBMs typically establish a list of drugs called a formulary, both generic and brand name, that are covered under a particular health plan. Accordingly, a practitioner finds it useful when writing a prescription to know which medications will be covered for a given patient. To that end the system 10 provides a data selection field 154 in the form of a “drop down” list. The system 10 will first attempt to identify the patient's PBM through the transmission of patient demographic data to third party systems. Third party systems will attempt to identify the PBM and transmit the PBM to system 10 using industry standard methods. If system 10 receives positive identification of the selected patient's PBM from third party systems, the PBM is automatically selected and displayed in data selection field 154. If the PBM is not displayed, a list of known PBMs can be viewed by clicking on the drop down button 156, with the user selecting the patient's PBM/formulary, if known, by clicking on it. The adjacent checkbox 195 allows for setting the Medicare plan displayed in filed 154 for the selected patient. Once the PBM/formulary is set, any medication search conducted for the selected patient will indicate the formulary compliance of the medication in accordance with the selected PBM. The field 154 may of course be left blank.

As mentioned above, a series of tabs positioned across the screen 134 just below data entry field allow for viewing patient data. Tab 160 allows for viewing the patient's prescription claims history, i.e., the patient's medication history compiled by the PBM through pharmacy claims made against the patient's insurance card, which may include medications not prescribed using the system 10 of the present invention. Data 159 regarding the patient's prescription claims history as shown on screen 161 in FIG. 6C may be obtained by the host computer 20 via network 19, the host computer 18 communicating with a third party computing resource 16, e.g., a server, operated by the selected patient's PBM or health plan, in a manner well known by those of skill in the art. A drop down box 156 and associated button 157 allows for selecting the date range of the claims history, with a series of buttons 155 allowing, respectively from right to left, for refilling a prescription written for a selected prescription, with any prescription so selected being automatically transmitted for refill to the pharmacy connected to the selected patient; adding the selected prescription to the active prescriptions list as displayed on screen 580 (FIG. 6B), or printing the selected claims. Prescriptions are selected for the operations performed by buttons 155 by clicking the appropriate check box 570 as with the previous screens. Selection fields 572, 574 allow the user to limit the history to only prescriptions written by the user. The default is for prescriptions written by any authorized user, the data 159 shown upon clicking tab 160. Get history button 576 initiates the search for claims history, with the results displayed in accordance with selection fields 572, 574, one of which is always selected. The current settings of drop down box 156 and selection fields 572, 574 can be set as defaults by clicking in check box 577

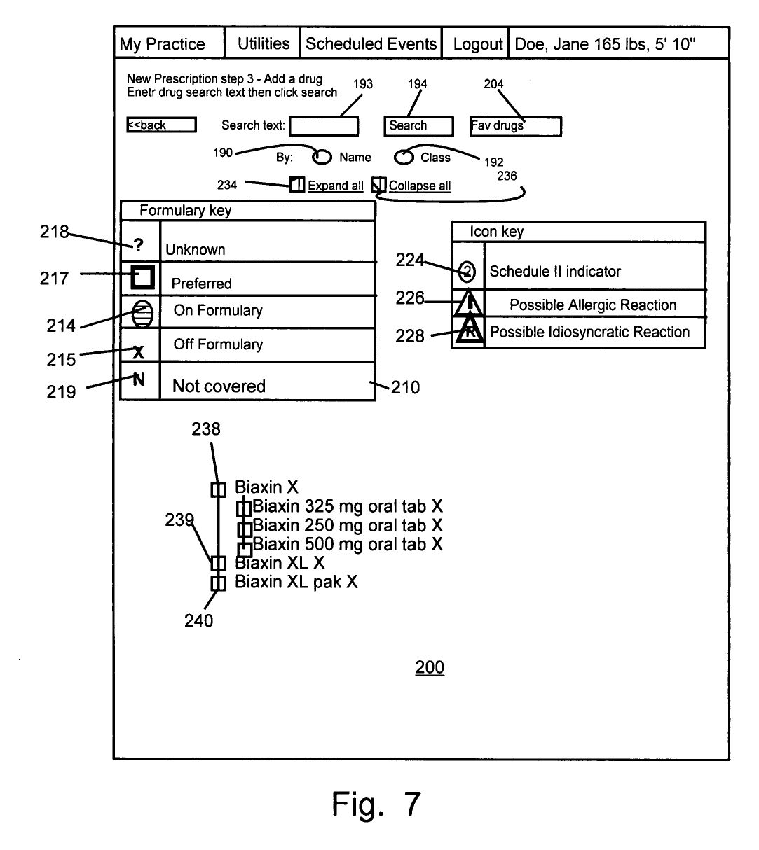

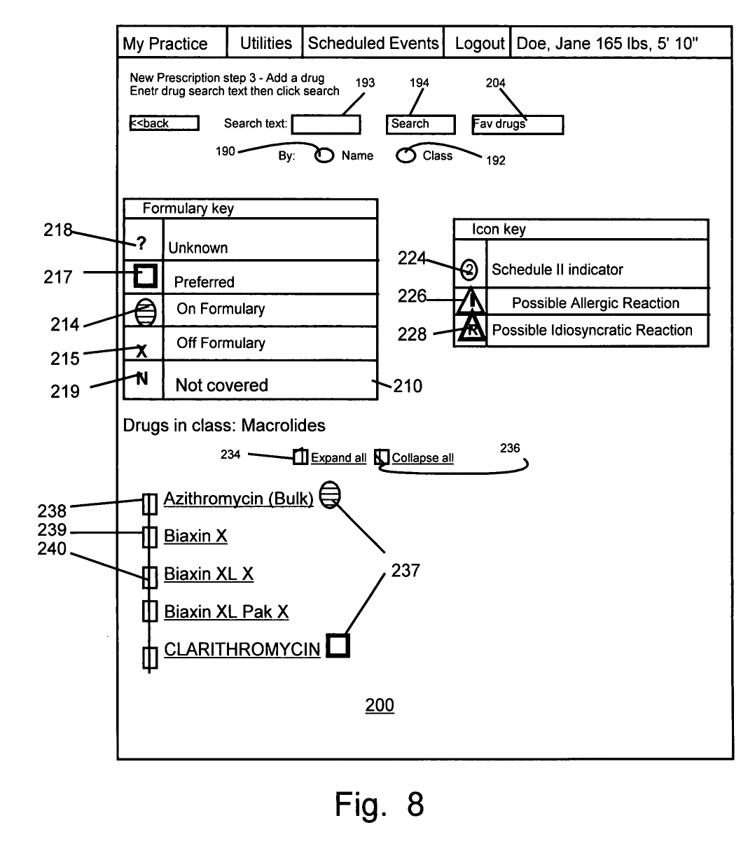

Clicking on tab 582 displays the active prescriptions screen 584 in FIG. 6B for the selected patient. All current prescriptions for the patient are listed, with each prescription 586 listed in column 588 with a check box 590. Columns 592 and 593 list the date the prescription was entered into the system 18 and the authorized user who created it respectively. The prescriptions 586 are presented in hyperlink format allowing the user to click to view the sig information. Button 594 allows the user to add a new medication and when clicked, advances the user to advance to the screens of FIG. 7 or 8 to add a sig for the medication as will be described below. Button 596 allows the user to remove a prescription which has been selected via check boxes 590. Button 598 prints the entire list.

Clicking tab 162 displays a screen 163 (FIG. 6D) for viewing or entering the selected patient's allergies, i.e., medications to which the patient is allergic. It can be seen that the screen 163 displays a list of medications 165 to which the selected patient is allergic arranged in rows. Each medication 165 has a check box 167 positioned adjacent thereto for selecting a medication for deletion, via button 169, or printing. The add new button 171 allows the user to add new medications to the list 165, clicking on the button 171 produces a data field (not shown) which permits entering the medication data. It can be seen that among the data entered regarding the medication is the date the medication was added to the list.

Clicking on tab 164 produces a screen (not shown) for viewing and entering any notes regarding the patient which are deemed relevant to the medication selection process. Tab 168 allows the user to toggle back to the patient data screen 134 (FIG. 6A) when viewing the other screens (FIGS. 6B-6E, as well as the notes screen described immediately above) in the series of screens related to patient data.

Clicking on tab 170 generates a list of voided prescriptions such as that shown in FIG. 4B as has been previously discussed, only limited to the selected patient.

Referring again to FIG. 6A a drop down menu 172 allows the user to select the option of viewing all prescriptions written for the selected patient using the system 10, or optionally, prescriptions written in the last 6 months, 1 year, or two years. A check box 174 allows the viewing option set by the drop down menu 172 to be saved as the default option for the current user.

Immediately below drop down menu 172 are a series of buttons 176, 178, 180, which allow for refilling, discharging, or reinstating prescriptions selected via check boxes 138, respectively. Button 181 displays a screen which permits adding a selected non-active prescription to the active prescriptions list as described below, which list can be viewed by clicking on button 582 to display screen 580 as shown in FIG. 6B as discussed above. Also, all prescriptions which are active are highlighted, e.g. in blue shading, on screen 134, with the non-active prescriptions shown on screen 134 not highlighted to allow the user to readily distinguish between the two. Thus, the user can determine all the prescriptions which are active by viewing the highlighted entries on screen 134, or viewing all entries on screen 580. A fifth button 182 in the series initiates printing of the list 135.

A current diagnosis of all conditions for the selected patient can be viewed by clicking on button 185 to display screen 600 as shown in FIG. 6E. The conditions 602 are listed in grid 602, each with a check box 604, to allow for various actions to be carried out; and a text box indicating the date the condition was added. Add new button 606 allows for adding new conditions, activate button 608 allows for activating previous conditions which have been deactivated, deactivate button 609 deactivates, but does not remove a selected condition, and remove selected 610 removes the condition. The print button 612 prints the list.

As has been previously stated, the search for a particular medication for the selected patient is initiated by entering the appropriate text in text box 152, the medications searchable by either class or name, selectively, by clicking the appropriate field 190, 192, the fields indicated by text indicia. Clicking the search button 194 starts the medication search subroutine, the third step in the prescription writing process of the system 10, resulting in the display of the screen 200 shown in FIG. 7. The user may wish to view a list of favorite medications by clicking on favorite medications button 204 prior to initiating the prescription writing process, which causes the display of a list of medications typically prescribed by the user in hypertext format, the list functioning in a manner identical to the lists of FIGS. 7 and 8 which will now be discussed.

It can be seen that the top left hand area of the screen 200 includes the same buttons and fields as found on screen 134. Namely, search button 194 and associated fields 190, 192 for selecting the scope of the medication search, a back button 202 for returning to the previous screen, and a favorite medications button 204. Search button 194 and associated fields 190, 192, back button 202, and favorite medications button 204 appear on all screens associated with the prescription writing process. As is common with html based web pages, the back button ensures that the system 10 reliably returns to the immediately prior screen, obviating the use of the “back” button associated with the web browser. Also, the toolbar 206 remains essentially the same, having buttons for accessing various screens and utilities as has been previously discussed. In the upper right hand corner of the screen 200 are two lists of icons which allow the user to quickly visualize the status of any medication discovered during the search. List 210 contains formulary key icons. A drug formulary is a list of medications covered by a specific health plan, which list usually designates certain medications as on formulary, off formulary, or unknown for the particular patient for whom the prescription is being prepared. It should be noted that the data for determining the formulary, etc. status of the medications can be stored on the host computer 20, or obtained in real time from a computer resource 16 associated with the current patient's health care provider. Medications on the formulary are generally covered by the patient's health care provider. Medications off the formulary are generally not covered, although some may be covered under special circumstances. Key icons in the list 210 may be visually distinguishable by color, shading, or shape, or any combination of color, shading, or shape. In a preferred embodiment of the invention, formulary key icons are designated to have different shape and color, in this case a red circle icon 214 for on formulary, black X 215 for off formulary, a green square icon 217 for preferred, and a black question mark (?) icon 218 for unknown formulary. Medications not covered are indicated by the character N icon 219 which may also be black. As stated above, a database containing the health plan's (or PBM) formulary may be accessed by the host computer 20 via network 19, the database being stored either on a server 16 associated with the patient's health plan or on one of the host servers 20.

Icons 224, 226, and 228 provide additional indications about medications discovered during the search. Icon 224 is a schedule II indicator, icon 226 indicates a possible allergic reaction based on the selected patient's data (as opposed to known allergies as discussed above), and icon 228 indicates a possible idiosyncratic reaction, also based on the patient's data. Icons 224, 226, and 228 preferably have different shapes and colors than the formulary key icons so that a user may readily distinguish between the two. The user may, at any time a list of drugs produced as a result of a search is displayed, expand or collapse to show or hide, respectively, additional information about all of the drugs in the list in a manner consistent with lists of files displayed with WINDOWS® EXPLORER® as will be explained below.

Another key aspect of the system 10 is the flexibility afforded users searching for medications to prescribe to a selected patient. Medications may be searched for in one of three ways. First, the user may select to search for a medication by name, by clicking in field 190 and entering all or part of the name of the medication he/she is considering in text filed 193, and clicking the search button 194. Second, the user may search for a medication by therapeutic class, by clicking in field 192 and entering all or part of the name of the medication class in text field 193, and clicking the search button 194. Third, the user may click on the favorite medications button 204, which displays a list of previously prescribed medications, which may be listed alphabetically or in order of frequency of use.

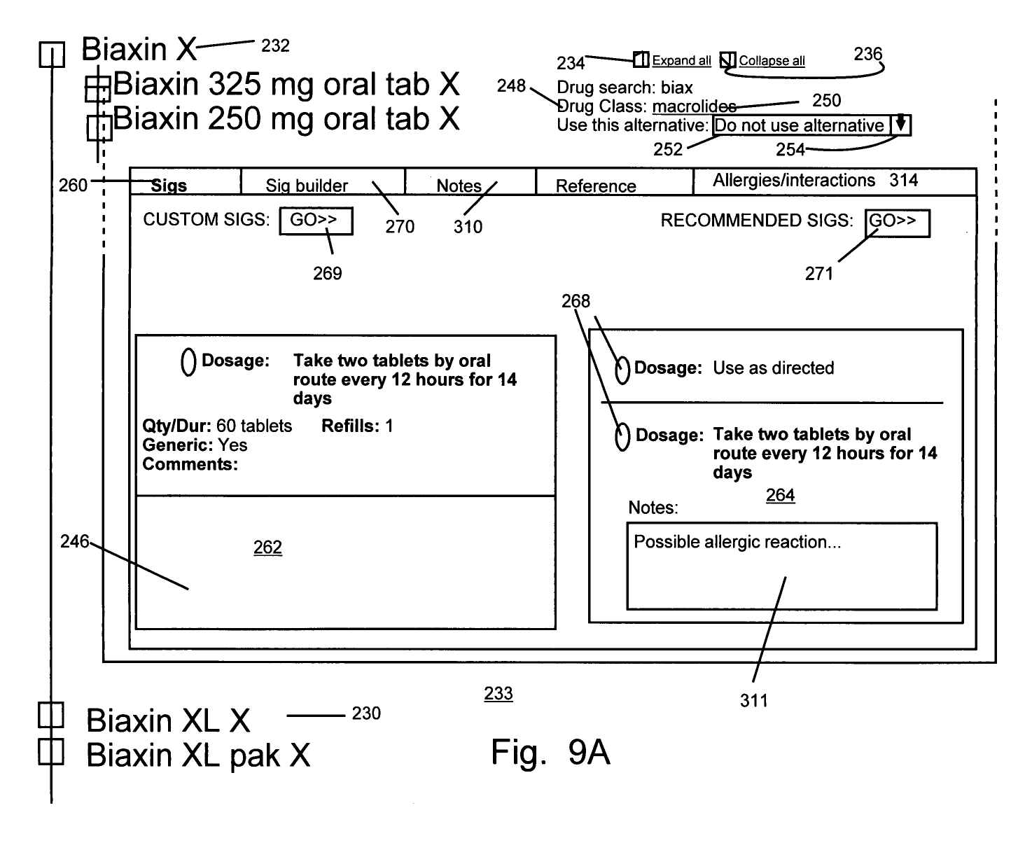

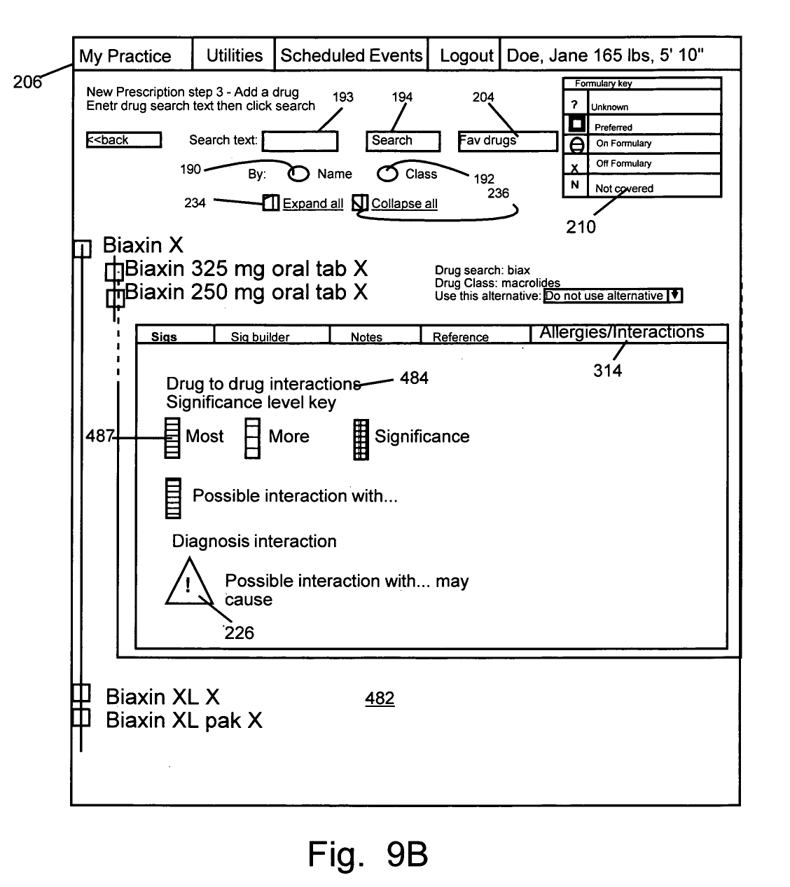

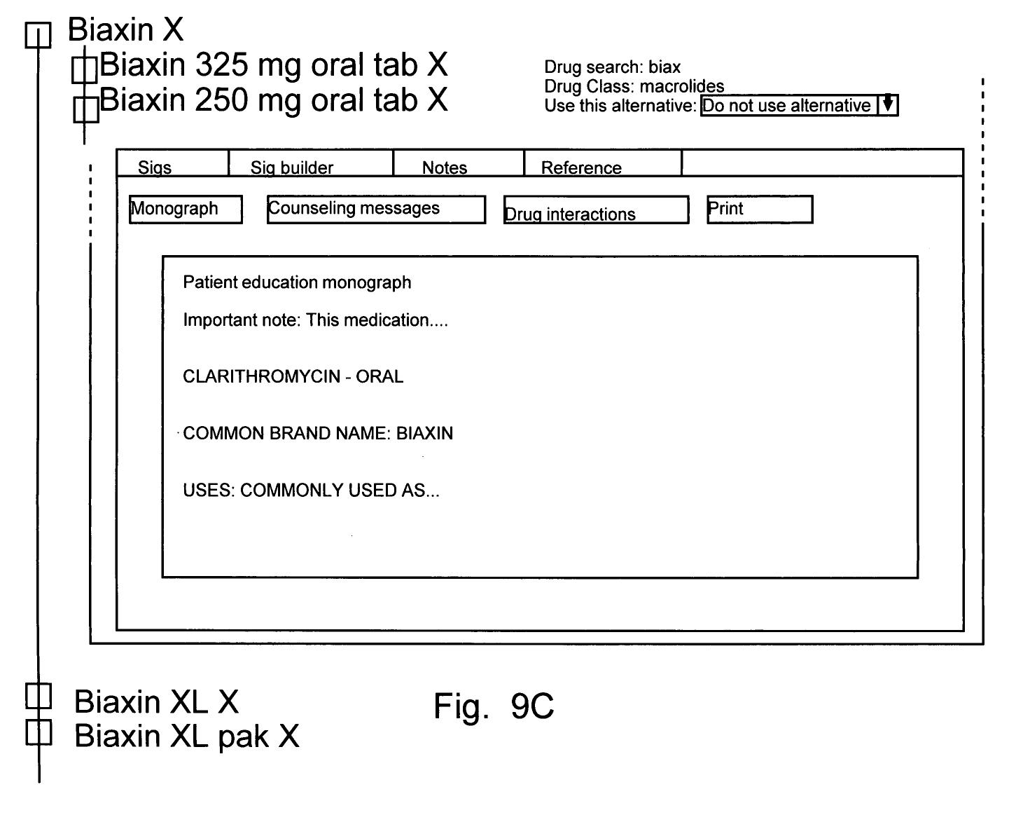

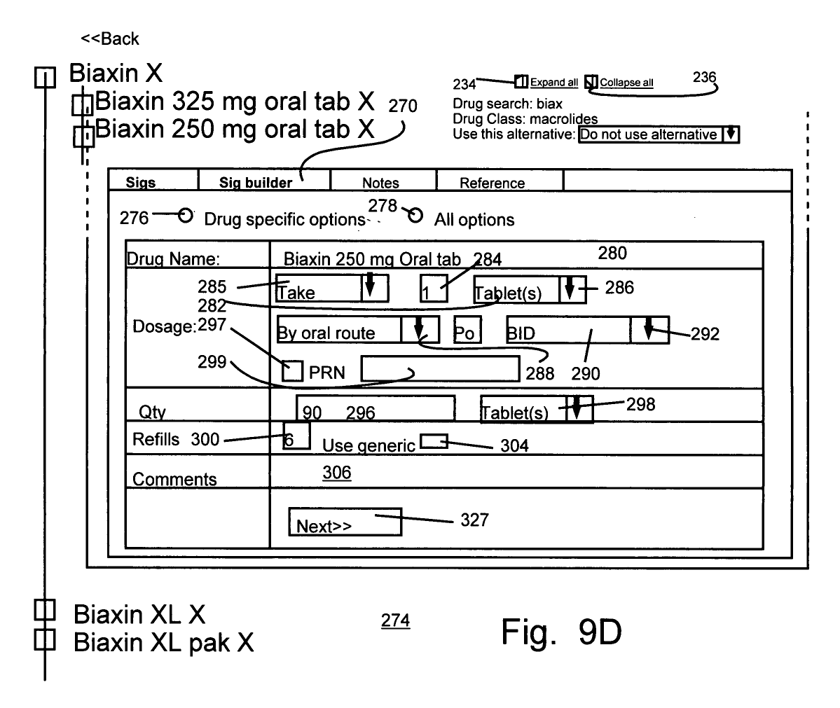

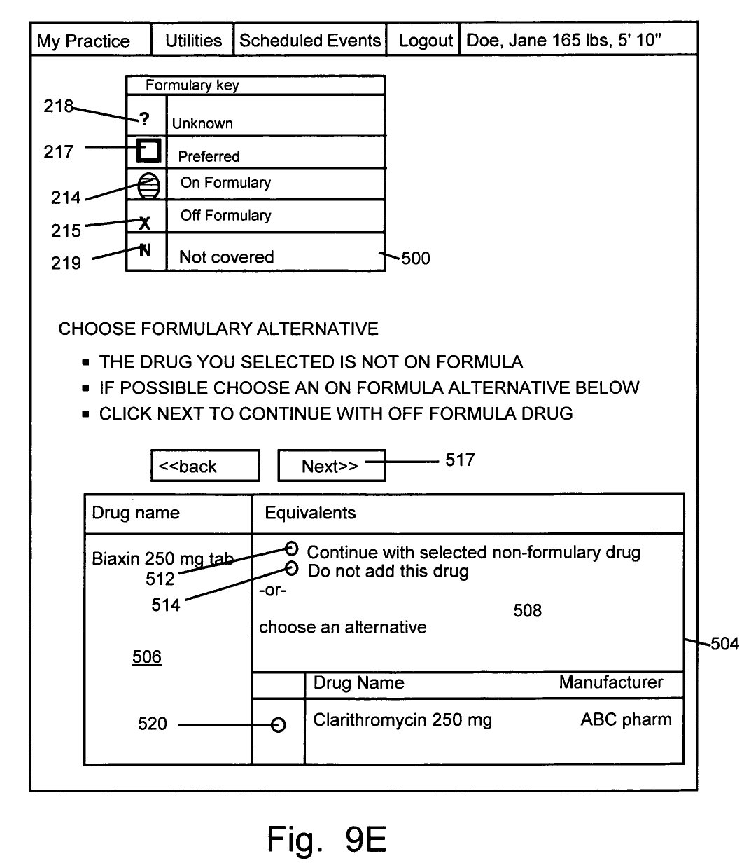

The search results are displayed as an expandable list 230 of medication candidates, which may be in hyperlink text format. Clicking on a single medication 232, or the “+” icon associated therewith in standard WINDOWS® FORMAT, displayed in the list allows the user to view dosage and other information associated with the selected medication as can be seen on screen 200 as well as screen 233 in FIG. 9A. The entire list 230 may be expanded to show the dosage etc. by clicking the expand all button 234, and collapsed by clicking collapse all button 236. A sample search and the ensuing results are shown in FIG. 7. In the example shown the search query is “biax”, and the medication is searched by name by clicking in the field 190 and then clicking the search button 194, which generates a three entry list consisting of the medications “Biaxin” 238, “Biaxin XL” 239 and “Biaxin XL Pak” 240. If the medication was searched for by class, e.g., macrolides, by clicking in field 192 and clicking search button 194, a similarly arranged list, albeit with different (additional) entries, would result as shown in FIG. 8 and described below. By way of example, and again for the particular patient selected, entry 240 has a black X formulary key icon 214 positioned next to it indicating that the medication is “off formulary”. Additional icons, as appropriate, are automatically positioned next to entries 238, 240 to give the user additional indications about the status, class, etc. of any medication found as a result of the search. Again, the information about a particular patient's status as regards the selected medication is obtained via network 19 from either host computing facility 18 or other network resources 16. The desired medication 232 is then selected for prescription based upon formulary and other criteria as would be apparent to a skilled practitioner, by clicking on any entry 232 in the list 230 causing the display of screen 233 (FIG. 9A).

If a medication is searched for by class, a list of medications as shown in FIG. 8 is shown. It can be seen that the list 237 in the example shown, which includes all medications classified as “Macrolides”, also includes Biaxin 238 as found in the previous search which used the truncated search term “biax”. A medication 232 is then selected by clicking on an entry 232 in the list 237 as described above.

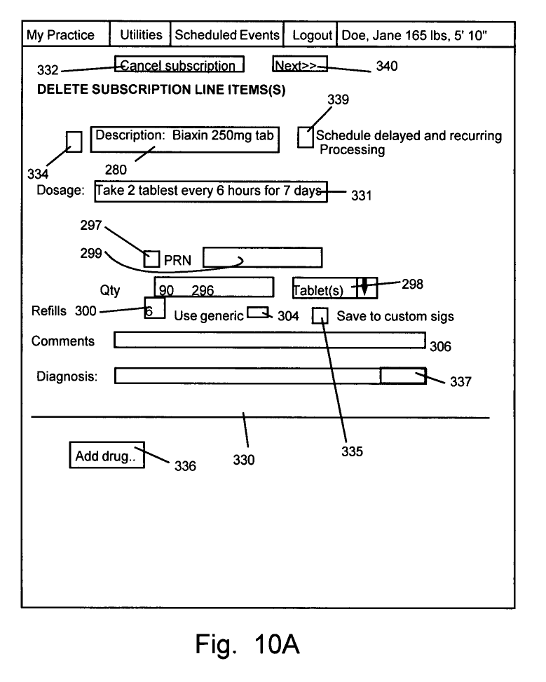

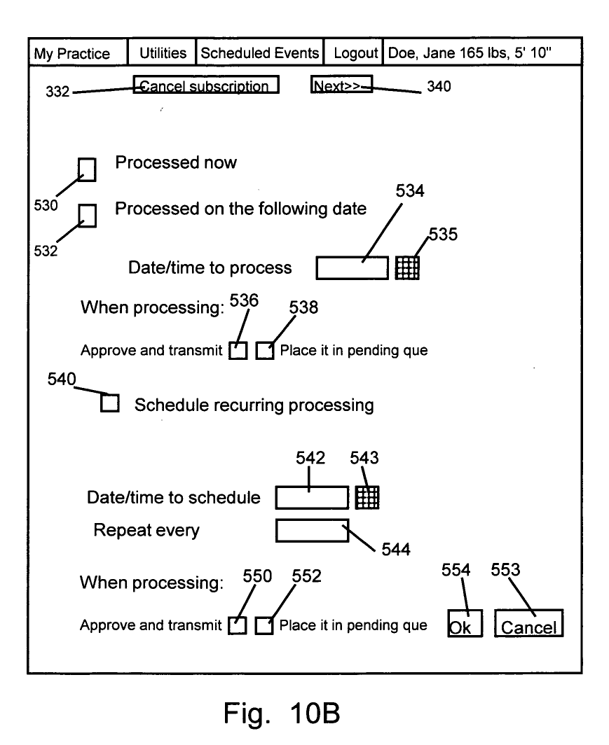

Once a medication is selected using either of the search methods described above, a new series of screens beginning with the “sig” screen 233 in FIG. 9A, and including FIGS. 9A-E can be accessed. It can be seen that list 230 remains on screen 233 and the selected (i.e. previously clicked on) entry from the list 230 is expanded to include dosage options. A series of tabs appearing in FIGS. 9A-9D to allow for completion of the prescription writing process in accordance with the system 10 of the invention. The area 246 of the screen 233 containing the expanded medication information is sectioned off from the rest of screen 233 and includes a first line of text 248 and associated hyperlink 250 identifying the drug class of the selected medication. Clicking on the hyperlink 250 results in the display of all medications in the indicated class, resulting in a new list 230 and the display of (i.e. return to) screen 200 of FIG. 8. A drop down box 252 allows the user to select from a list of alternative medications by clicking on button 254, and then clicking on the desired alternative medication. The alternative medication is then displayed on screen 233, including the expanded area 246, and also positioned among other similarly classified medications, in exactly the same manner as the originally selected medication. The expanded area 246 is further characterized by the provision of a series of tabs as mentioned above, with the leftmost tab 260 being arbitrarily designated as the “sigs” tab resulting which returns the user to FIG. 9A when browsing any of screens 9B-9D, displaying screen 233, as does clicking on or selecting a medication in either FIG. 7 or 8 as has been mentioned. As is well known in the art, the “sig” comprises the instructions for use of the medication given to the patient by the prescriber. Accordingly, clicking on the sig tab 260 to return to FIG. 9A or advancing to FIG. 9A from screen 200, results in the display of several optional patient instructions divided into two columns 262, 264. Column 262 contains a practitioner's custom sigs, or sigs that he/she has previously used for the selected medication 240. Column 264 contains an FDA approved sig, i.e., a recommended sig, for the selected medication 240. Positioned below column 264 are any notes/warnings 311 associated with the medication as relates to the particular patient, which are automatically supplied from the servers 20. The notes 311 may include warnings concerning allergies or drug interaction which may prompt the user to select another medication or modify the sig. If the notes 311 contain warnings concerning allergies or drug interactions, the user is prompted to click on the allergies/interactions tab 314 for additional information, the tab 314 being highlighted or otherwise visually distinguishable from the other tabs. The user may select sigs in either column 262, 264 by clicking in the either of the respective selection fields 268. If either a custom or recommended sig has been selected, the user may then click on the appropriate “go” button 269, 271, which causes the display of either a sig review screen (FIG. 10A) or a formulary alternative screen (FIG. 9E) as will be explained below.

If the user chooses to build a sig for the selected medication, clicking on the sig builder tab 270 causes the initiation of the sig builder subroutine and display of screen 274 as shown in FIG. 9D. Screen 274 includes several fields allowing for the entry of all information required for the sig. The sig builder screen 274 includes two check fields 276, 278 which allow the user to select either drug specific options or all options. For example, if the medication is manufactured as a tablet then clicking the “drug specific option” will provide sig building options for prescribing a tablet only. Typically a sig for prescribing a tablet will use “take” by oral route so the sig builder will NOT offer options such as inject, infuse, inhale, or spray but rather “take”. Continuing with our example, the sig builder will offer “by oral route” and NOT by inhalation route, by rectal route, or by vaginal route. The drug name is listed along with the dosage of each tablet (or concentration/purity etc. if liquid or cream) in text box 280. A drop down box 282 is associated with text box 284, the drop down box 282 allowing the user to select between the various forms of the medication (tablet, capsule) described in text box 280, the text box 284 allowing the user to identify the amount/quantity of the medication to be ingested/applied per dose. Drop down menu 285 identifies the method of using/applying the medication. Drop down menu 286 allows the user to identify the form of the medication, i.e., liquid, tablet, capsule, etc. Drop down menu 288 lists the various methods of ingesting/applying (e.g., orally, topically) medication, so that the user can select a method of taking the medication consistent with the form of medication as indicated in drop down menu 286, with box 289 containing a pharmaceutical abbreviation, e.g. PO of the method displayed in box 288. Drop down menu 290 allows for entry of the interim between doses or number of daily doses (e.g. twice daily etc.) as selected from drop down button 292. The total quantity of medication may be entered into text box 296, with drop down menu 298 again allowing the user to enter the form of the medication, which of course must be consistent with the form identified in box 282, with the system automatically setting the information in box 298 in accordance with that previously entered in box 282. PRN (as required) text box 299 includes information on the symptoms which may require an additional dose of the medication e.g., a persistent cough, etc., as is well known in the art. PRN check box 297 must be checked prior to entering text in box 299. Text box 300 allows the user to set the number of refills, while the user may select “generic” or “ ”no generic” from drop down menu 304 to indicate to the pharmacist whether generics may be prescribed. Any relevant comments may be entered into text box 306. When the sig builder screen 274 has been completed, and all notes, reference materials, and alerts have been read by clicking on the appropriate tabs as discussed below (and factored into the sig building process as described below), the user can then click on the next button 327 which will cause the display of either the formulary alternative screen shown in FIG. 9E, or the sig review screen shown in FIG. 10A as will be explained in more detail below.

The group of tabs, including tabs 260 and 270 appearing across the series of screens in FIGS. 9A-9D, which group also includes tabs 310, 312, and 314, allow the user to more safely and efficiently prepare the prescription in light of the myriad difficulties inherent with the sig building process such as drug interactions, FDA alerts, etc. Tabs associated with the active screens are highlighted or otherwise differentiated from non-active screens as is known in the art. Specifically, tab 310 allows for searching for and displaying any notes from the patient's insurance provider or the drug manufacturer, which notes may be obtained by the system 10 from any trusted source via the internet 19 or, input by a system 10 administrator, or by any other means as would be apparent to one of skill in the art. Clicking on tab 310 initiates a search for any such notes on both the host servers 20 or any database or resource 16 available thereto and relevant for the particular patient for whom the prescription is being written. Any notes uncovered during the search will be displayed on the screen (not shown) associated with the notes tab 310, and also in an area 311 just below column 264 on screen 233. The notes displayed (preferably in red or otherwise highlighted to be differentiable from other text displayed on the screen) in area 311 will also include any allergy/drug interaction warnings associated with the medication, and alert the user to click on tab 314 which is also highlighted. Reference materials regarding the medication, acquired as described above in connection with the notes tab 310, are displayed by clicking on tab 312 to display screen 313, the reference materials containing information to educate the patient concerning the proper use of the medication, the conditions the medication is typically used to treat, and any other information the patient should know concerning the medication. Specifically, the reference materials are broken down into several categories, each individually accessible for display on screen 313 via buttons 317, 318, 319, and 320. Clicking on button 317 results in the display of the patient education monograph, in industry standard format. Counseling messages regarding proper use of the drug may be viewed by clicking button 318, warnings concerning the drug may be viewed by clicking button 319, and drug interactions may be viewed by clicking button 320. It can be appreciated that the information obtained by clicking tabs 317-320 may be overlapping or redundant as is often the case when researching medications on the internet in general. Also, all of the information on screen 313 may be selectively viewed by dragging the scroll bar button 323. Clicking button 321 initiates printing of the reference information contained on screen 313.

Clicking on tab 314 results in the display of any drug-to-allergy interaction or any drug- to-drug interactions on screen 480 in FIG. 9B, the data relating to the interactions being either stored on the host computer 18, or available thereto via the internet. The data is arranged as a series of text line entries 482 under either of two main headings, drug to drug interactions 484, or drug to allergy interactions. A plurality of significance level keys 487 allow the user to determine at a glance the severity of the interaction as determined by data stored on the system 18, and the medication indicator icons 224, 226, 228 may be positioned next to text line entries to provide further indication to the user about the nature of the interaction. The search is triggered upon the initial drug search as described above in reference to FIGS. 7 and 8 and the drug or allergy interactions tab 314 will be highlighted in red or other distinctive color on all of the screens 9A-9D to alert the user during the sig selection or the sig building process. The drug interactions are checked against the patient's active medications list icon as displayed on screen 187 in FIG. 6B. The allergy interactions are checked against the patient's allergies as listed on screen 163.

Once the sig has been completed using either the custom sigs, the recommended sig, or the sig builder subroutine, the user must click on either go button 269, 271 associated with the custom or recommended sigs respectively, or the next button 327 associated with the sig builder subroutine to advance to the next step in the prescription writing process. If the medication selected is not on formulary for the particular patient, clicking on either of buttons 269, 271, or 327 will initiate the display of screen 326 as shown in FIG. 9E. Screen 326 includes a grid 500 having a list of formulary keys as described above providing a reference for the user. Text 502 positioned at the top of the screen 326 alerts the user that the selected medication is off formulary, and includes instructions for selecting an alternative medication. Framed area 504 positioned immediately adjacent grid 500 is partitioned into areas 506 and 508 under headings indicating that the selected medication name and the pharmaceutical equivalents therefor, respectively, are listed below. The name of the selected medication is displayed in box 506, while selection fields 512 and 514 are positioned in box 516, the fields 512, 514 affording the user the option to either continue with the selected medication 512, or drop the selected medication 514, before clicking the next button 517. If the user decides to choose an alternative medication, and an alternative, i.e., an equivalent, is available, a list of alternatives, each with a check field 520 is positioned in box 508. The list of equivalents is generated in response to a user clicking on either of buttons 269, 271, or 327, and only when a sig for a non-formulary medication has been completed. As mentioned above, medication searches triggered by any of the subroutines of the system 10 in response to various user actions, are executed by the host computer 20 on any database or resource 16 available thereto and relevant for the particular patient for whom the prescription is being written. Thus, the user has three options to advance from screen 326. First, the user may continue with the non-formulary medication by clicking in check field 512, and then clicking the next button 517 to advance to the sig review screen (FIG. 10A). Second, the user may choose not to add the selected non-formulary medication and thereby end the sig writing process by clicking in check field 514 and then clicking the next button 517 which returns the user to the screen of FIG. 6A if no additional medications are awaiting the sig review process, or to the screen of FIG. 10A if additional medications, for which a sig has been previously prepared but not finalized, are pending sig review. Finally, the user may choose to add another medication by clicking in check field 520, and then clicking the next button 517 to return to screen 233 to prepare a sig for the alternative medication.

Once the user has completed the sig preparation process and advanced to the sig review subroutine of the system by any of the methods described above, screen 330 is displayed.

Screen 330, shown in FIG. 10A, has several editable fields indicating the various parameters pertaining to the sig, specifically, the information contained in text boxes and fields 282, 284, 286, 288, 290, 297, 299, 300, 298, and 316 as described above. It should be noted that the information in text boxes 284, 286, and 288 are combined and displayed as a single text box 331, thus simplifying the presentation of the sig prior to final review by the practitioner. A cancel prescription button 332 may be clicked to cancel the medication if desired. The editable sig screen 330 may include more than one prescription, in which case a specific medication or medications may be canceled by clicking on its check box 334, which is positioned next to every sig on screen 330, prior to clicking on next button 340. Also, the user may choose to edit the prescription information and create a compound medication in which case check box 333 is checked and text fields 280 and 331 are modified accordingly. A check box 335 allows for saving the prescription to custom sigs, causing the prescription to be entered into the system 10 for the selected patient, and displayed in response to clicking on button 269 on screen 233. The patient's diagnosis from screen 600 may be accessed in capsule form by clicking tab 337 which allows for viewing the information in a drop down text box. Delayed and/or recurring processing of the prescription may be scheduled at any time by clicking icon 339 or by clicking next button 340, provided that all necessary fields, namely, 331, 296, and 300, have been filled out.

If the user wishes to add another medication, add medication button 336 may be clicked which returns the user to screen 200, affording the user the options of building a new sig for the medication to be added, or using a custom or recommended sig. Otherwise, if the user finds the sig (or sigs) acceptable, the next button 340 may be clicked, which advances the user to a prescription scheduler dialog box 341 as shown in FIG. 10B.

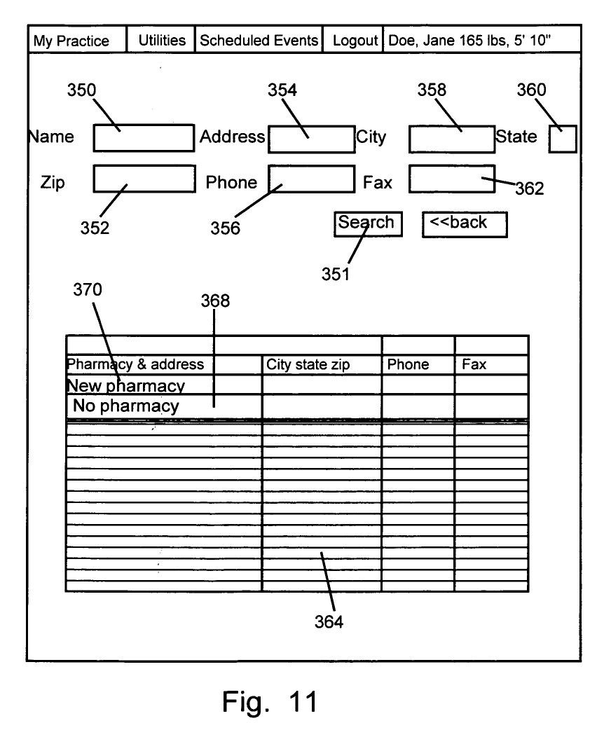

The dialog box 341 includes check fields 530 and 532 allowing the user to schedule processing of the prescription. Specifically, the user may schedule the prescription for immediate processing by clicking in check field 530, or optionally delay processing until a later date which is entered into data entry field 534. A calendar icon 535 displays a calendar of the present month when clicked, and the desired date may be clicked in the well known manner and automatically entered into field 534, along with the time information which is manually entered. Check field 536 allows for instant approval and transmission to a selected pharmacy, whereas check field 538 allows the user to enter the prescription into the prescriptions to approve list (FIG. 4A). Clicking check box 540 and entering the appropriate data in corresponding fields 542, 544, 546, and 548 allows for scheduling recurring processing with the date/time to begin the schedule entered into field 542, with calendar icon 543 functioning as noted above; the frequency entered into field 544 which includes a drop down box activated by clicking button 545 to select from a set of discrete increments; and the end date, if any, entered into field 548. The approve and transmit 550 and prescriptions to approve 552 fields function as described above with respect to identical fields 536 and 538. The user may cancel scheduling at any time by clicking the cancel button 553. Once the dialog page has been completed, the user clicks the OK button 554 and then the next button 556 to advance to the pharmacy search screen 344 shown in FIG. 11.

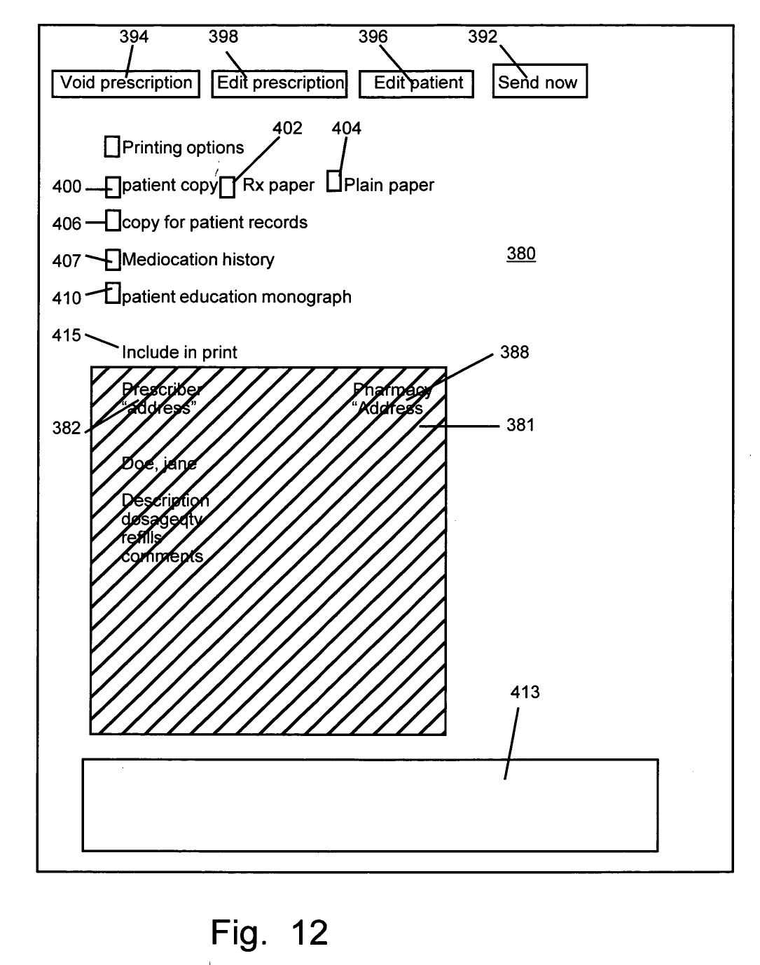

The pharmacy search screen 344 will display the patient's 5 most recent pharmacies to which the system 10 has transmitted prescriptions for the patient. The pharmacy search screen allows the user to search for a pharmacy using a variety of different criteria which can be selectively entered into one or several of the search fields 350-360. For example, typing a portion (truncation) of a pharmacy name in the name field 350, e.g., “wal”, and clicking the search button 351 would cause the display of all Wal-Mart® and Walgreen® pharmacies, preferably limited by geographical area by entering information in the zip 352, city 358, or state 360 fields, with the pharmacy name, address, phone and fax arranged in columnar form. If no information is entered in fields 352, 358, or 360, and the search is not further narrowed by entering the address, phone, or fax number in the appropriate fields, 354, 356, and 362 respectively, the results displayed in grid 364 will be national in scope. Mail house or internet pharmacies are all stored with a zip code of 00000, these pharmacies may be accessed by typing the full pharmacy name in the name field 350, and typing “00000” in the zip code field 352. If the prescription is to be printed on secure prescription paper to be given directly to the patient, the no pharmacy field 368 is clicked. If a pharmacy cannot be found, or if the user otherwise wishes to enter a new pharmacy, the new pharmacy field 370 is clicked which generates a form (not shown) which allows user input regarding the new pharmacy, which may include pharmacy name, pharmacy address, pharmacy facsimile number, and pharmacy phone number which is transmitted to computing resource 18 for verification and storage for future access. Pharmacies listed in grid 364 may be listed as hyperlinks, and clicking on a particular pharmacy results in the display of the prescription preview page 380 as shown in FIG. 12. Page 380 is also displayed if the no pharmacy field is clicked. The prescription preview page 380 (FIG. 12) displays a representation 381 of the actual prescription as it would appear on prescription paper, complete with all of the customary information such as, the prescriber's name and contact information 382, the pharmacy name and contact information 384, patient identification data 386, date 388, the sig 390, and other pertinent information as is necessary and customary. From screen 380 the user has several options for submitting the prescription, once it has been reviewed and verified by the user, as indicated by the various buttons and check boxes positioned above image 381. First, the user may simply click on the send button 392, which will transmit the prescription directly to the pharmacy indicated at 384. If the user has reviewed the prescription and decided it is incorrect, redundant, inappropriate, etc. she may simply void the prescription by clicking on the void button 394. If either the patient data or the prescription needs to be edited, the user may click on the edit patient 396 or edit prescription 398 buttons. Clicking on the edit patient button 396 causes the display of a data entry screen with fields as shown in the upper portion of screen 120. Allowing the user to enter the appropriate correction data. Clicking on the edit prescription screen causes the display of screen 330 where the user may enter corrections as needed. After corrections are made the send button 392 may be clicked to transmit the prescription to the pharmacy, thereby ending the prescription writing process. Alternatively, the user may terminate the prescription writing process by printing a hard copy of the prescription on either plain paper or prescription paper by clicking in check box 400 and the appropriate paper selection field 402, 404, and hitting the enter key on the users computer 12 keyboard. The system 10 will then initiate the print routine by presenting a list of Microsoft Windows enabled printers as setup on the user's computer 12, 13. An additional copy of the prescription for the patient's records may be printed on regular paper by clicking in check box 406. Reference information, i.e., the patient education monograph, may be printed by clicking in box 410. The patient's medication history on the system 10 may be printed by clicking in box 407, limited to a specified date range as selected by the user via drop down box 409 and associated button 411. Screen 380 also displays the patient interaction data as a described above, as aeries of lines of text 413, the text selectively included in the printed version of the prescription by checking box 415.

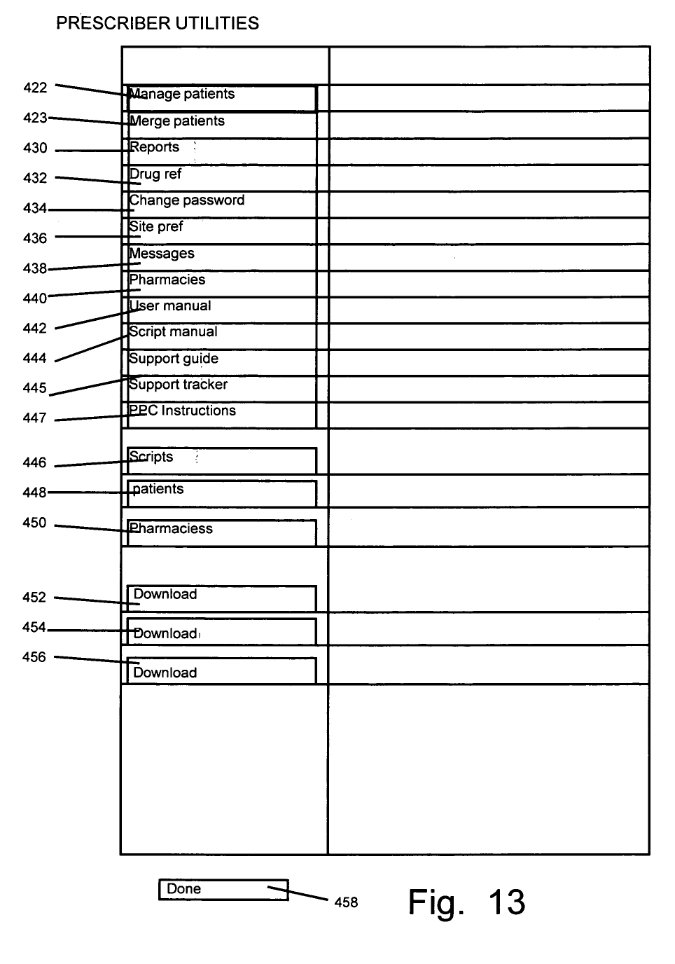

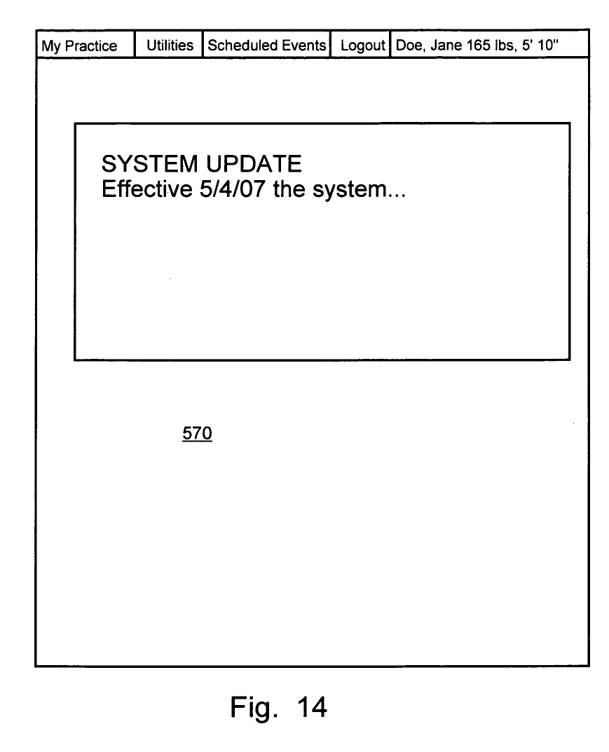

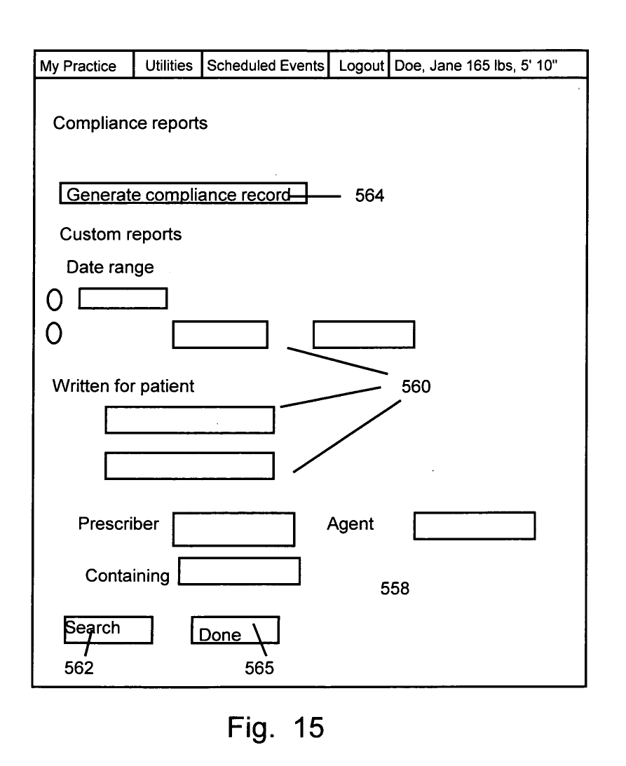

FIG. 13 shows the prescriber utilities screen. The screen, generally indicated by the numeral 420, includes a list of utilities which the user may access to perform various tasks on the system. Page 420 may be accessed by clicking on the utilities button which appears on all top of the screen toolbars, 102, 150, etc. The manage patients button 422 allows for managing patient data. Clicking on the manage patients button 422 displays a screen having a list of the user's patients, presented as hyperlinks. A selected name may be clicked and various fields associated with the patient (e.g., address, phone number) are shown, in editable form, allowing the user to make desired modifications. Clicking the merge patient data button 423 displays a screen having all patient data, i.e., all prescriptions written on the system displayed on a singe, scrollable screen (not shown). Clicking the reports button 430 displays the reports screen 558 as shown in FIG. 15, which allows the user to select various reports, for example, prescription writing history for a selected patient. Dialog boxes 560 allow for entering various search parameters such as patient name, date range, prescriber, medication, or ID number, to allow the user to customize the report. Once the search parameters have been selected, the search button 562 is clicked to initiate the search and display the results in the form of a text box containing the desired report, if any. Clicking the done button 565 closes the reports window. A compliance report, generated by clicking on button 564, is a listing of all prescriptions written by the authorized user. Compliance reports are automatically generated periodically, the period for each user determined by the time differential between the first and second report generated by the user. The drug reference button 432 can be clicked to display a dialog box which allows the user to enter a drug name, which drug can then be searched to retrieve information regarding use, side effects, etc. The change password button 434 allows the user to change the log in password. entered in box 26. Clicking on the site preferences button 436 allows the user to set various preferences for the site such as positioning and content of toolbars etc. as is well known in the art. Messages button 438 functions identically to the message buttons in the top of the screen toolbars 122, 150, etc., and causes the display of screen 570 as shown in FIG. 14. Screen 570 displays any system 10 messages such as notices regarding updates, system maintenance, etc. as entered and transmitted by the system administrator. Pharmacies button 440 allows for display of a screen for entering pharmacy information such as that shown on screen 344, with editable fields for entering the required data which should include at least the address, phone and fax numbers, in addition to the name of the pharmacy. An html or adobe version of a user's manual may be obtained by clicking on button 442. Information regarding the use of Scriptguiderx™ may be obtained in adobe or html format by clicking button 444. System 10 support, i.e., help, troubleshooting, etc., can be accessed by clicking support button 455. Documentation and other information for using the pocket PC version of the system software, which functions identically to the system as described above, is obtained by clicking on button 447. Button 446 through 450 can be used to coordinate hotsync operation with any PDA. Specifically, the scripts button 446 allows for editing of the prescriptions, the manner previously described, to be synchronized, the patients button 448 allows for editing the patient list to be synchronized, while the pharmacies button 450 allows for editing the pharmacy list to be synchronized. Software for installing a PDA can be downloaded by clicking button 452, with related buttons 454 and 456, respectively, allowing for downloading updates, and updates with uninstaller software for removing any previous versions of the system 10 software. When finished the user may click the done button 458 to close the utilities window.

The system 10 also allows the system administrator to send text messages to users, i.e. computers 12, 13 and to that end an HTML link 46 is provided, with associated text to indicate the presence of unread messages. Link 46 directs the user to messages screen FIG. 14 which lists all messages 47, both read and unread, which have not been deleted.

Also, in accordance with certain state pharmacy board regulations compliance reports must be printed on a regular basis and to that end the application software of the system 10 includes a reports subroutine which prompts the user via a single line text message displayable on screen 34 having an embedded hyperlink 49 therein, the hyperlink 49 directing the user to the screen 52 (FIG. 15) associated with the reports subroutine. The reports module may also be used to generate custom user reports using any of the predefined fields as shown on the reports screen 52.

For convenience, links 46 and 49 are shown on the patient data screen 34 as this is the first screen the user encounters after log-in. Of course the links 46 and 49 could be provided on any of the screens to described previously.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

What is claimed is:

1. A prescription creation and management software system for managing one or multiple patients implemented on one or more user operated electronic computing devices comprising a program embodied on a computer-readable medium, the system being for use by a prescriber to create an electronic prescription prescribing a drug treatment for a patient condition exhibited by a selected patient, and for managing, maintaining, and periodically updating all electronic files stored on or accessible to a host computer system, relating to one or several patients including:
a patient data screen containing prescriber obtainable data regarding patient identity;
a prescription writing screen allowing the prescriber to initiate a prescription creation subroutine which allows access to all data pertinent for creating a prescription for the selected patient for a selected pre-diagnosed condition;
a prescription preview screen allowing the prescriber to preview a prescription created using the subroutine initiated upon accessing the prescription writing screen; and,
a prescription output screen allowing the prescriber to transmit an electronic prescription to a designated pharmacy based upon predetermined criteria.

2. The system of claim 1 wherein data entered on said patient data screen is used to allow said host computer to determine user identity and level of system access.

3. The system of claim 1 wherein said prescription creation subroutine causes said prescriber to review and modify as necessary several predetermined parameters in order to complete a prescription.

4. The system of claim 1 wherein said patient data screen can display several alert and status icons.

5. The system of claim 4 wherein said alert and status icons are color and shape coded.

6. The system of claim 1 wherein said prescription creation subroutine includes several screens for reviewing and entering prescription parameters, at least some of which have color and shape coded icons for indicating various parameters associated with the prescription writing process.

7. The system of claim 1 including a system utilities screen which allows prescriber access to a plurality of subroutines useful for system and patient data management.
